(19) United States
(12) Patent Application Publication
(10) Pub. No.: US 2015/0129502 A1
(43) Pub. Date: May 14, 2015

(54) GRAPHENE OXIDE-MODIFIED MATERIALS FOR WATER TREATMENT

(71) Applicant: THE TRUSTEES OF THE STEVENS INSTITUTE OF TECHNOLOGY, Hoboken, NJ (US)

(72) Inventors: Xiaoguang Meng, Piscataway, NJ (US); Jianfeng Zhang, Jersey City, NJ (US); Christos Christodoulatos, Basking Ridge, NJ (US); George Korfiatis, Basking Ridge, NJ (US)

(73) Assignee: THE TRUSTEES OF THE STEVENS INSTITUTE OF TECHNOLOGY, Hoboken, NJ (US)

(21) Appl. No.: 14/541,323

(22) Filed: Nov. 14, 2014

Related U.S. Application Data
(60) Provisional application No. 61/904,114, filed on Nov. 14, 2013.

(51) Int. Cl. C02F 1/28; B01J 20/32; B01J 20/20

(52) U.S. Cl. CPC C02F 1/283; B01J 20/205; B01J 20/3234; C02F 1/281; C02F 2101/20
USPC 210/660; 252/176; 427/215

(57) ABSTRACT

A graphene oxide adsorbent for removing dissolved substances from water or other liquids comprises a substrate having a coating layer of graphene oxide. The dissolved substances may be dissolved heavy metals, radioactive compounds, or other organic and inorganic substances. The substrates may be particulate substrates. The substrates may be adsorbents. The graphene oxide adsorbents can be beneficially used in filters and batch reactors, among other devices, for water treatment and for environmental remediation. In some embodiments, graphene oxide alone may be used as the graphene oxide adsorbent,

### CROSS-REFERENCE TO RELATED APPLICATION

The present application claims the benefit of U.S. Provisional Patent Application No. 61/904,114, filed on Nov. 14, 2013, the disclosure of which is incorporated by reference herein.

### FIELD OF THE INVENTION

The present invention relates to materials and processes for improving environmental quality, more particularly to the use of graphene oxide to remove dissolved substances from water or other liquids.

### BACKGROUND OF THE INVENTION

Graphene oxide (GO) is a two-dimensional nanosheet compound that has sp²-hybridized carbon atoms arranged in six-membered rings. Graphene oxide flakes may have one to ten layers of graphene oxide, lateral dimensions of about ten nanometers (nm) to hundreds of nm, and thicknesses of about 0.7 nm to about 1.2 nm, although flakes or sheets having other dimensions or numbers of layers may be obtained. Additionally, GO is highly negatively charged with large specific surface areas near about 2600 m²/g and high concentrations of functional groups, such as the hydroxyl (C—OH), epoxyl (—O—), carboxylate (—COOH), or other oxygen-containing groups, at the edges and on the face of the GO nanosheets. As a result of these unique properties, GO is a promising material for the treatment of water, and, especially, for adsorption of chemicals therefrom.

Numerous studies have been conducted on removal of heavy metals by GO, graphene, and composite materials prepared using graphene. GO alone (i.e., without other adsorbents) has been tested for removal of such dissolved metal cations as Cu, Pb, Eu, U, and Co. The results have shown GO's efficacy for removal of these elements, as well as for the removal of other elements and substances. However, handling GO in liquids can often be uneconomical or impractical.

### SUMMARY OF THE INVENTION

The present invention utilizes GO to modify the surface of various substrates, which are preferably low cost adsorbents, to generate effective adsorbents for removal of substances, such divalent cations, dissolved heavy metals, radioactive compounds, non-metallic anions, and other substances, from water and other liquids. Because of the extremely high specific surface area and high reactivity of GO, only a small amount of GO is needed to modify a large amount of low cost particulate materials. In embodiments of the present invention, the new adsorbents can be used in conventional unit operations for water treatment.

### BRIEF DESCRIPTION OF FIGURES

For a more complete understanding of the present invention, reference is made to the following detailed description of exemplary embodiments considered in conjunction with the accompanying drawings, in which:

FIG. 1 is a plot of the batch removal of dissolved lead by graphene oxide (“GO”) introduced into a dilute aqueous solution of lead, according to an embodiment of the present invention;

FIG. 2 a plot of an isotherm of lead adsorption from a dilute aqueous lead solution by GO, according to an embodiment of the present invention;

FIG. 3 is a plot of an isotherm of lead adsorption isotherm from a dilute aqueous lead solution by graphene oxide-activated carbon adsorbent (“GO-AC”), and a lead adsorption isotherm of activated carbon without GO, according to an embodiment of the present invention;

FIG. 4 is a plot of the removal of dissolved lead from a dilute aqueous solution by GO-AC in a column filtration process, according to an embodiment of the present invention;

FIG. 5 is a plot of the removal of dissolved strontium from a dilute aqueous solution by GO-AC in a column filtration process, according to an embodiment of the present invention; and

FIG. 6 is a plot of an isotherm of calcium adsorption from drinking water by GO in a batch treatment process, according to an embodiment of the present invention.

### DETAILED DESCRIPTION OF THE INVENTION

In embodiments of the present invention, new adsorbents with high adsorptive activity and capacity are developed by modifying solid substrates with GO. In other embodiments, adsorbents for the removal of dissolved substances from water and other liquids comprise GO on a substrate.

The preparation and efficacy of an embodiment of the present invention will be described with reference to an exemplary graphene oxide-activated carbon (GO-AC) prepared according to a process that is also an embodiment of the present invention. It should be understood that this description is merely exemplary and is not intended to limit the scope of the present invention. A person having ordinary skill in the art will recognize that other compositions and methods of preparing and using the present invention are possible and that such other compositions and methods are intended to fall within the scope of the present invention.

The GO used in the experimental examples presented herein was a single-layer GO with lateral dimensions in the range of 300 nm to 800 nm, and thicknesses in the range of 0.7 nm to 1.2 nm. The same GO was used to prepare the GO-AC used in the experimental examples. The AC used to prepare the GO-AC was obtained from Nichem Co. (Newark, N.J.), and had a typical surface area of greater than 500 square meters per gram.

The exemplary graphene oxide-activated carbon (GO-AC) samples were prepared by mixing 10 mL of 100 mg/L GO suspension with 5.0 g (dry weight) of washed activated carbon substrate (AC) on a rotary mixer overnight. The solid was then separated from the suspension and dried overnight, which was carried out at a temperature of 45° C. The solid GO-AC had a GO content of about 0.2%. It is believed that the GO forms a coating layer of GO on at least a portion of the surface of the AC.

In other embodiments of the present invention, the GO-modified adsorbents may be prepared according to the following procedure: a GO suspension is prepared by dispersing GO in water or solvent using ultrasonication or another suitable dispersal method. Water with low salt concentration, preferably a low concentration of multivalent cations, is used for the preparation of the suspension. In some embodiments, the water is essentially full of multivalent cations. The suspension pH is adjusted to about neutral (i.e., 7.0) to increase the stability of the GO nanosheets. Substrates, such as activated carbon, activated alumina, iron oxides, titanium oxides, aluminum silicates, or zeolites, are added into the suspension and mixed so that the GO bonds to the surfaces of the substrates, thereby producing GO-substrates.

In other embodiments, the substrate can be pretreated with chemicals, such as, for example, Al(III) or Fe(III) solutions, or with binders to improve the bonding affinity of the GO to the substrate. Then, a GO suspension or GO nanoparticles in solid form or in suspensions can be mixed with the pretreated adsorbents to form the GO coating.

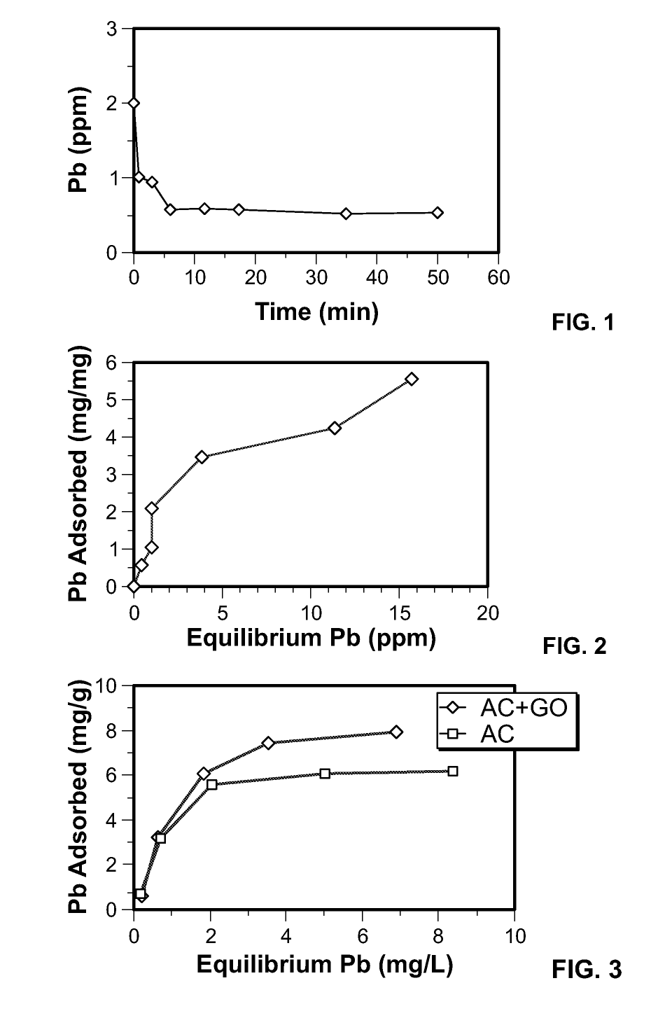

FIG. 1 is a plot of the batch removal of dissolved lead by GO introduced into a dilute aqueous lead solution. The concentration of GO was 5.0 mg/L, the initial lead concentration was 2 mg/L, and the pH of the solution was in the range of 4.6-6.2. FIG. 1 shows that the use of GO rapidly removed dissolved lead from solution, reducing the concentration of dissolved lead from 2 mg/L to 1 mg/L within one minute after introduction of the GO. The equilibrium concentration of lead was reached in about 6 minutes from the introduction of GO.

FIG. 2 a plot of an isotherm of lead adsorption from a dilute aqueous lead solution by GO at a final pH of 5.5. The concentration of GO was 5.0 mg/L, the final pH was in the range of 5.4 to 5.5. Samples of solution were collected three hours after the introduction of GO into the lead solution. As can be seen, the amount of lead adsorbed increased continuously with increasing equilibrium lead concentration. In the present embodiment, about 5.5 mg of lead was adsorbed per 1 mg of GO at an equilibrium concentration of 16 mg/L. This adsorption capacity corresponds to a much higher adsorption capacity than existing adsorbents, such as activated carbon, activated alumina, iron oxides, titanium oxides, aluminum silicates, and zeolites, for example.

FIG. 3 is a plot of a lead adsorption isotherm of the GO-AC discussed above and a lead adsorption isotherm of activated carbon without GO. For each series of batch adsorption tests used to develop the isotherms, the adsorbent was present at a concentration of 1.0 g/L, and the final pH was in the range of 6.91-6.96. Samples of the solution were collected 4 hours after the introduction of the adsorbent into the lead solution. As can be seen, when the equilibrium lead concentration was above 4 mg/L, the activated carbon was saturated by lead at an adsorption capacity of about 6 mg/g. On the other hand, the lead adsorption capacity of GO-AC continued to increase with increasing equilibrium lead concentration from 4 mg/L to 7 mg/L. Based on these results, the adsorption capacity of GO-AC was calculated to be 16 mg/g using the Langmuir equation.

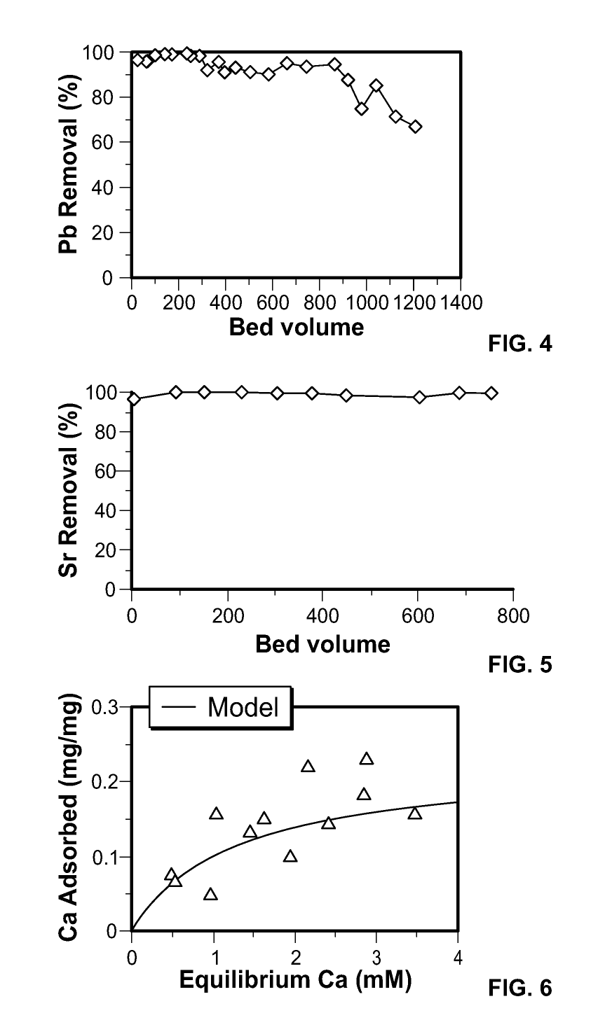

FIG. 4 is a plot of the removal of dissolved lead from a dilute aqueous lead solution by GO-AC in a column filtration process. A column with an inside diameter of 0.5 inches was packed with 6.8 mL of the GO-AC discussed above. A solution containing 2 mg/L of dissolved lead at pH 6.0 was pumped through the column at an empty bed contact time (EBCT) of 20-40 min. Filtrate samples were collected to analyze the lead concentration with a furnace atomic absorption spectrophotometer. FIG. 4 shows that more than 90% of the lead was removed from solution by the GO-AC over at least 900 bed volumes of solution.

FIG. 5 is a plot of the removal of dissolved strontium from a dilute aqueous strontium solution by GO-AC in a column filtration process. A column with an inside diameter of 0.5 inches was packed with 6.8 mL of the GO-AC discussed above. A solution containing 0.5-0.6 mg/L of dissolved strontium at pH 7.2 was pumped through the column at an empty bed contact time (EBCT) of 20 min. Filtrate samples were collected to analyze the lead concentration with a furnace atomic absorption spectrophotometer. FIG. 5 shows that more than 97% of the strontium was removed from solution by the GO-AC over at least 750 bed volumes of solution.

FIG. 6 is a plot of a calcium adsorption isotherm for the adsorption of calcium from drinking water by GO. Adsorption of calcium by GO was tested by mixing a series of solutions containing 20 or 50 mg/L of GO and 1-4 mM Ca²⁺ in 50 mL centrifuge tubes on a rotary mixer. After overnight mixing, the samples were centrifuged at 10,000 rpm for 30 minutes. Supernatant samples were collected and passed through a 0.2 μm syringe filter for analysis of soluble Ca²⁺ concentrations using an inductively coupled plasma optical emission spectrometer (ICP-OES). The adsorption isotherm data (Δ) in FIG. 6 show that the amount of the adsorbed Ca²⁺ increased significantly with the increasing Ca²⁺ concentration from 0 to 2 mM, and increased gradually in the higher adsorption range. The model best-fit Langmuir isotherm calculated from the data points indicates that GO has an adsorption capacity for calcium of 212 mg Ca²⁺/g GO or 5.3 mmol Ca²⁺/g GO. These values are very high compared to the Ca²⁺ capacities of adsorbents such as AC, activated alumina, titanium oxides, or iron oxides. This unexpected result suggests that GO may also be effective in removing dissolved magnesium from aqueous solutions because of their similar chemistry in water, as well as in removing other alkaline earth cations. It also suggests that divalent cations other than the alkaline earth metals may be removed by GO, or GO combined with other adsorbents.

In a preferred embodiment, GO, GO-AC, or other GO-substrate combinations may be beneficially used for removal of dissolved substances such as heavy metals, radioactive compounds, inorganic anions, and other solutes from dilute aqueous solutions. In other embodiments, the GO-modified materials are used as catalysts for destruction of substances and for improving various chemical and biological processes.

Dissolved substances which may be removed from dilute aqueous solutions by GO, GO-AC, or other GO-substrate combinations include metal cations and non-metal anions. The types of metal anions which may be removed from dilute aqueous solutions by GO, GO-AC, and other GO-substrate combinations include, but are not necessarily limited to, divalent cations, rare earth metals, radioactive metals, and inorganic anions. Examples of metal cations which may be removed include aluminum, antimony, barium, cadmium, cesium, chromium, cobalt, copper, europium, gallium, gold, iron, lead, manganese, mercury, molybdenum, nickel, platinum, radium, selenium, silver, strontium, tellurium, tin tungsten, uranium, vanadium, and zinc. Certain oxides of the aforenamed metals may also be removed by GO, GO-AC, or other GO-substrate combinations. Inorganic anions which may be removed by GO, GO-AC, or other GO-substrate combinations include, but are not necessarily limited to, sulfate, phosphate, arsenate, arsenite, borate, nitrate, bicarbonate, carbonate, nitrite, silicate, sulfite, fluoride, chloride, bromide, and iodide. GO alone, GO-AC, or other GO-substrate combinations may be selected for optimum removal of the aforementioned substances by persons having ordinary skill in the art and possession of the present disclosure. Such substances may be removed by continuous flow through packed columns of adsorbent, by batch processes such as mixing the adsorbent in the liquid, followed by sedimentation of the adsorbent, or by other unit operations known in the art. By appropriate selection of adsorbents of the present invention, it would be possible to recover metals from the adsorbents by chemical washes or incineration of the adsorbent, or to recover the adsorbent as a solid mass for destruction or disposal.

GO, GO-AC, or other GO-substrate combinations, may be used to remove radioactive metals from nuclear process water. For example, since GO is shown herein to effectively remove dissolved calcium and strontium, it should also be effective for the removal of dissolved radium. Without being bound by theory, it is believed that larger cations should form stronger bonds with the carboxylate groups present on GO. As a result, GO, GO-AC, and other GO-substrates should have a higher adsorptive capacity for larger cations, such as Ra²⁺, than for smaller cations, such as Ca²⁺. Thus, it may be expected that large monovalent radioactive cations, such as Cs⁺, or other large cations such as those of the actinide or lanthanide series, may also be removed by GO, GO-AC, or other GO-substrate combinations.

It should be understood that the embodiments described herein are merely exemplary in nature and that a person skilled in the art may make many variations and modifications thereto without departing from the scope of the present invention. All such variations and modifications, including those discussed above, are intended to be included within the scope of the invention.

We claim:

1. A method for removing dissolved substances from an aqueous stream, comprising the step of contacting an adsorbent that includes graphene oxide with an aqueous stream that contains a dissolved inorganic substance.

2. The method of claim 1, wherein the adsorbent consists essentially of graphene oxide.

3. The method of claim 1, wherein the adsorbent includes graphene oxide adsorbed onto a particulate substrate.

4. The method of claim 3, wherein the particulate substrate is selected from the group consisting of an activated carbon, an activated alumina, an iron oxide, a titanium oxide, an aluminum silicate, and a zeolite.

5. The method of claim 3, wherein the particulate substrate is an activated carbon.

6. The method of claim 1, wherein the dissolved inorganic substance includes one or more of aluminum, antimony, barium, cadmium, cesium, chromium, cobalt, copper, europium, gallium, gold, iron, lead, manganese, mercury, molybdenum, nickel, platinum, radium, selenium, silver, strontium, tellurium, tin, tungsten, uranium, vanadium, or zinc.

7. The method of claim 1, wherein the dissolved inorganic substance includes one or more of sulfate, phosphate, arsenate, arsenite, borate, nitrate, bicarbonate, carbonate, nitrite, silicate, sulfite, fluoride, chloride, bromide, or iodide.

8. The method of claim 1, wherein said contacting step includes filtering the aqueous stream through a particulate bed containing the adsorbent.

9. The method of claim 1, wherein said contacting step includes adding the adsorbent to the aqueous stream, agitating the aqueous stream and adsorbent, and separating the adsorbent from the aqueous stream by sedimentation.

10. The method of claim 1, wherein said contacting step includes adding the adsorbent to the aqueous stream, agitating the aqueous stream and adsorbent, and separating said adsorbent from the aqueous stream by filtration.

11. A particulate adsorbent, comprising graphene oxide and a particulate substrate, wherein graphene oxide is adsorbed to a surface of said particulate substrate.

12. The particulate adsorbent of claim 11, wherein said particulate substrate is selected from the group consisting of an activated carbon, an activated alumina, an iron oxide, a titanium oxide, an aluminum silicate, and a zeolite.

13. The particulate adsorbent of claim 12, wherein said particulate substrate is an activated carbon.

14. A method of making a particulate adsorbent, comprising the steps of preparing a suspension of graphene oxide, contacting a particulate solid with the suspension, separating the particulate solid from the suspension after said contacting step, and drying the particulate solid.

15. The method of claim 14, wherein the particulate solid is selected from the group consisting of an activated carbon, an activated alumina, an iron oxide, a titanium oxide, an aluminum silicate, and a zeolite.

16. The method of claim 14, wherein the particulate solid is an activated carbon.

17. The method of claim 14, wherein the graphene oxide includes graphene oxide flakes.

18. The method of claim 14, wherein said preparing step includes the steps of dispersing the graphene oxide in a solvent to form a dispersion and adjusting the pH of the dispersion to neutral.

19. The method of claim 18, wherein the solvent is water that is essentially free of multivalent cations.

20. The method of claim 14, including the further step of treating the particulate solid with one or both of an Al(III) compound or an Fe(III) compound prior to said contacting step so as to increase the bonding affinity between the graphene oxide and the particulate solid.
